(19) United States
(12) Patent Application Publication
(10) Pub. No.: US 2006/0274420 A1
(43) Pub. Date: Dec. 7, 2006

(54) Optical element and method for making the same

(75) Inventor: Ching-Chou Chang, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/437,938

(22) Filed: May 19, 2006

(30) Foreign Application Priority Data
Jun. 3, 2005 (CN) 200510035137.1

(51) Int. Cl. G02B 1/10

(52) U.S. Cl. 359/588; 359/586

(57) ABSTRACT

An optical element includes a substrate having a first surface and an opposite second surface; a first film stack formed on the first surface, having a plurality of first film layers with predetermined thickness or layer numbers; and a second film stack formed on the second surface, having a plurality of second film layers with same thickness or layer numbers to the first film layers. A method for manufacturing the optical element is also provided.

### TECHNICAL FIELD

The present invention relates to optical elements, especially to an optical element having a multi-layer structure and a method for manufacturing the same.

### BACKGROUND

Optical films are widely used in many fields, such as digital cameras, microscopes, etc. Generally, optical films are made from a stack of dielectric films or metal films with a multilayer structure, which are used to change the characteristics of incident light.

Methods for manufacturing optical films include steps where coating, polishing, cutting and cleaning take place. Because of the stress between different layers and the substrate, when being cut, warp, blisters or holes will occur in the optical films. Accordingly, later steps will be affected, thus leading to high defective rates, poor stability and unreliability

Stress existing between multi-layers of optical films can be classified into two types according to warp direction of film stack, that is, tensile stress and compressive stress. Under tensile stress, optical films tend to extend outwards from the substrate, at the same time, optical films have elasticity to balance the tensile stress. When tensile stress exceeds the elasticity limit, optical films will break or warp. While under compressive stress, optical films tend to bend inwards towards the substrate, elasticity of the optical films balances the compressive stress. When compressive stress exceeds the elasticity, optical films tend to curl towards the substrate, thus blistering other layers of optical film.

A mask with multiple layers is provided, the mask includes a film with multiple layers, which are formed on a substrate. The film includes a plurality of layer groups, each layer group includes at least two layers, a first material layer taking on a compressive stress, and a second material layer taking on a tensile stress. Each layer has a thickness in the range from 0.5 nanometers to 10 nanometers. Stress on the film is in the range from −50 MPa˜50 MPa. However, the mask can only be used on products that need a combination of tensile stress and compressive stress, and therefore cannot fit the need for optical elements made of particular materials aiming to obtain pre-determined optical properties.

Therefore, a heretofore-unaddressed need exists in the industry to address the aforementioned deficiencies and inadequacies.

### SUMMARY

In one aspect of the present invention, an optical element is provided. The optical element includes: a substrate having a first surface and an opposing second surface; a first film stack formed on the first surface, having a plurality of first film layers with predetermined thickness or numbers of layers; and a second film stack formed on the second surface, having a plurality of second film layers with same thickness or numbers of layers to the first film layers.

In another aspect of the present invention, a method for manufacturing an optical element is provided. The method includes the steps of: providing a substrate having a first surface and an opposite second surface; forming a plurality of first film layers with predetermined thickness or numbers of layers on the first surface, thus forming a first film stack; and forming a plurality of second film layers with same thickness or numbers of layers as the first film layers on the second surface, thus forming a second film stack.

Other advantages and novel features will become more apparent from the following detailed description when taken in conjunction with the accompanying drawings.

### BRIEF DESCRIPTION OF THE DRAWINGS

Many aspects of an optical element and a method for making the same can be better understood with reference to the following drawings. The components in the drawings are not necessarily drawn to scale, the emphasis instead being placed upon clearly illustrating the principles of the composite mold and the method for making the same. Moreover, in the drawings, like reference numerals designate corresponding parts throughout the several views.

FIG. 1 is a schematic, cross-sectional view showing an optical element of a preferred embodiment, and

FIG. 2 is a flow chart of a method for manufacturing the optical element of FIG. 1.

### DETAILED DESCRIPTION OF THE EMBODIMENTS

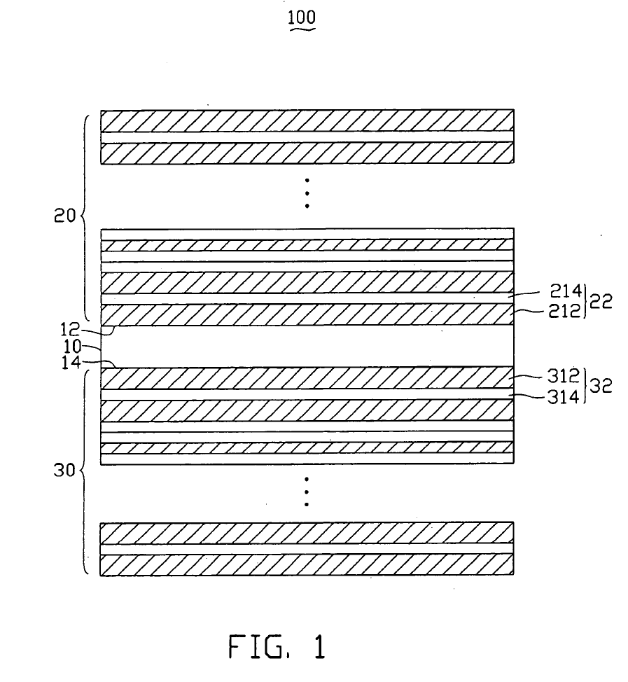

Referring to FIG. 1, an optical element 100 comprises a substrate 10, a first film stack 20 and a second film stack 30. The substrate has a first surface 12 and an opposite second surface 14. The first film stack 20 is formed on the first surface 12, and the second film stack 30 is formed on the second surface 14. The substrate 10 is made of quartz or optical glass materials, with a thickness in the range from 0.1 millimeters to 0.5 millimeters.

The first film stack 20 includes a plurality of first film layers 22, which have predetermined thickness or layers. Each of the first film layers 22 includes a high refractive index film layer 212 (abbreviated as H) and a low refractive index film layer 214 (abbreviated as L). A thickness of each layer is about one fourth of a wavelength. The wavelength is selected according to functions of the optical element 100. For example, if the optical element 100 is a thin film interference narrow band pass filter, the wavelength needed is a central wavelength of the narrow band that needs to be filtered. Deposition order of the high refractive index film layer 212 and the low refractive index film layer 214 can be settled according to optical properties of the optical element 100. Normally, the first film stack 20 can be deposited in alternating sequence to form a HLHLHL . . . structure, or can be deposited alternating intermittently to form a HLH(HH)LHL(LL) . . . structure, or other structures as required.

The second film stack 30 includes a plurality of second film layers 32. The second film layers 32 have same thickness or layers as that of the first film layers 22. Materials of the second film layers 32 are the same as or the equivalent of that of the first film layers 22, thus stress between the first film stack 20 and the second film stack 30 is balanced. The second film layers 32 also include a high refractive index film layer 312 (abbreviated as H) and a low refractive index film layer 314 (abbreviated as L). Deposition order of the high refractive index film layer 312 and the low refractive index film layer 314 can also be settled according to optical properties of the optical element 100.

Accordingly, the first film stack 20 and the second film stack 30 form effective layers of the optical element 100. When each layer of the first film stack 20 has similar thickness to each layer of the second film stack 30, the optical element 100 can be obtained as long as the number of layers of the two film groups is equal. Obviously, if the layers of one of the first film stack 20 and the second film stack 30 is thicker than that of the other, numbers of layers of the two film groups can be different, as long as the total thickness of the first film stack 20 and that of the second film stack 30 are substantially equal. The film group with thinner layers could have more layers than the other, thus the thickness of the first film stack 20 and the second film stack 30 could be made equal. In that way, the stress produced by the first film stack 20 and the second film stack 30 to the first surface 12 and the second surface 14 respectively could be balanced, and an effect to the optical element 100 caused by the stress could be decreased. For example, for an optical element having 38 layers of film layer in total, it could have 19 layers of high refractive index film on the first surface and 19 layers of low refractive index film on the second surface, each layer having uniform thickness. It could also have 10 layers of high refractive index film and 9 layers of low refractive index film on the first surface from bottom to top, and 9 layers of high refractive index film and 10 layers of low refractive index film on the second surface from bottom to top, thus stress borne by the two surfaces could be balanced, and an effect to the optical element 100 caused by the stress could be decreased.

Material of the high refractive index film layers and their corresponding refractive index could be chosen from the following group: tantalum oxide with a refractive index of 2.2, niobium pentoxide with a refractive index of 2.19, zinc sulfide with a refractive index of 2.27, silicon with a refractive index of 3.5, germanium with a refractive index of 4.0, tellurium plumbate (PbTe) with a refractive index of 5.0, etc. Material of the low refractive index film layers and their corresponding refractive index could be chosen from the following group: magnesium fluoride with a refractive index 1.38, thorium fluoride with a refractive index 1.47, cryolite with a refractive index 1.35, silicon oxide with a refractive index 1.47, aluminium oxide with a refractive index 1.63, and hafnium oxide with a refractive index 1.85, etc.

Since thickness of the film layers is proportionable to stress provided thereby, and the film groups 20, 30 formed on the surfaces 12, 14 respectively have same thickness or number of layers, rational distribution of the thickness or layer numbers of the film groups 20, 30 can balance stress borne by the two surfaces 12, 14, and further eliminate total stress on all the film layers of the optical element 100, thus preventing damage to the optical element 100 due to stress.

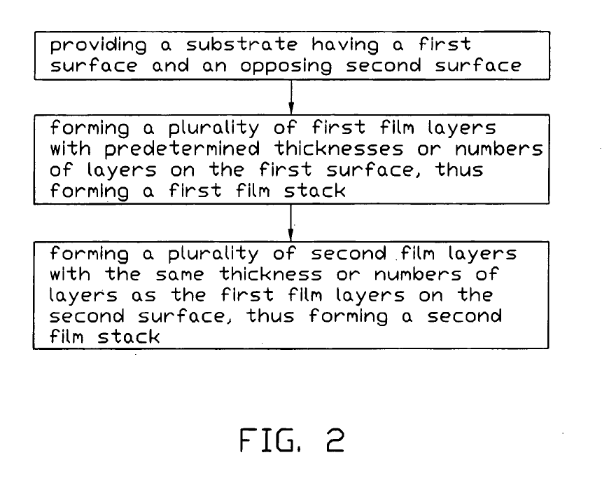

Referring to FIG. 2, a method for manufacturing an optical element is provided, which comprises the steps of providing a substrate having a first surface and an opposing second surface; forming a plurality of first film layers with predetermined thicknesses or numbers of layers on the first surface, thus forming a first film stack, and forming a plurality of second film layers with the same thickness or numbers of layers as the first film layers on the second surface, thus forming a second film stack.

First of all, a film material source is provided. The film material source could be an evaporation source, a sputtering target, etc. When multiple film layers with different materials are required, the film material source can include different types according to requirement.

Secondly, a substrate is provided having a first surface and an opposite second surface, assuming the first surface is placed facing the film material source. A plurality of first film layers are formed with predetermined thickness or number of layers on the first surface, thus forming a first film stack. Each layer of the first film stack can be formed on the first surface by ion coating, radio frequency sputtering, vacuum evaporating, or chemical vapor deposition processes. Thickness of the substrate is in the range from 0.1 to 0.5 millimeters. For this particular embodiment, each layer of the first film stack is formed by ion coating process, and a thickness of the substrate is 0.3 millimeters. Before coating, the position of the substrate to the film material source is adjusted, and the first surface is placed facing the film material source.

Preferably, to improve manufacturing efficiency, a plurality of substrates could be coated simultaneously. It is preferable to use a holding apparatus with an umbrella type or planetary type structure. A monitor and control system is also preferable to control thickness of layers, thus precision of film thickness can be improved. During coating, a first film stack is coated onto the first surface, which comprise high refractive index film layers and low refractive index film layers with predetermined thickness, each layer having a thickness equal to or substantially equal to one fourth of a wavelength. The above film layers can be formed by alternating deposition or intermittently alternating deposition processes, depending on the required functions of the optical element. Accordingly, first film stack having a plurality of first film layers with predetermined order is formed.

Thirdly, a plurality of second film layers are formed on a second surface opposite to the first surface, which have same thickness or number of layers as that of the first film layers, thus forming a second film stack. After forming the first film stack on the first surface of the substrate, the substrate is turned around to let the second surface face the film material source. Film layers are formed on the second surface by same methods as those on the first surface, thus the second film stack having same thickness or number of layers as the first film stack is formed. The first and second film stacks function to balance stress caused by the two surfaces of the substrate. In the preferred embodiment, the two film stacks on the two surfaces are both optical effective films, that is, they realize optical properties of the optical element together. In addition, these optical elements are not restricted to the structures above, other structures could also be workable. For example, an optical element could also have an optically effective first film stack on the first surface to realize required optical properties, and have an optically non-effective second film stack on the second surface to balance stress caused by the two surfaces.

In addition, the optical element of the preferred embodiment could also be manufactured by other methods, for example, the first surface and the second surface could be coated by film layers with same material and thickness alternatively, that is, in this method, the first surface and the second surface can be coated with alternating pattern. This method could prevent stress damages to the substrate when multi film layers are coated onto the same surface.

During the method for manufacturing the optical element, optical film stacks with particular thickness or numbers of layers are formed on two surfaces of the substrate, thus stress caused by the two surfaces is balanced. The method has advantages of simple manufacturing processes, convenient operation, and low cost.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An optical element comprising:
a substrate having a first surface and an opposite second surface,
a first film stack formed on the first surface, the first film stack having a plurality of first film layers with predetermined thickness or layer number, and
a second film stack formed on the second surface, the second film stack having a plurality of second film layers, the second film stack having same thickness, or same number of layers as the first film stack, so as to counterbalance internal stress caused by the first film stacks.

2. The optical element in accordance with claim 1, wherein at least one of the first film stack and the second film stack are optically effective film layers.

3. The optical element in accordance with claim 1, wherein at least one of the first film stack and the second film stack comprises a plurality of high refractive index film layers and low refractive index film layers.

4. The optical element in accordance with claim 3, wherein a thickness of either of each high refractive index film layer and each low refractive index film layer is one fourth of a reference wavelength associated with the optical element.

5. The optical element in accordance with claim 3, wherein materials of the high refractive index film layers are selected from the group consisting of: tantalum oxide, niobium pentoxide, zinc sulfide, silicon, germanium, and tellurium plumbate.

6. The optical element in accordance with claim 3, wherein materials of the low refractive index film layers are selected from the group consisting of: magnesium fluoride, thorium fluoride, cryolite, silicon oxide, aluminium oxide, and hafnium oxide.

7. The optical element in accordance with claim 1, wherein a thickness of the substrate is in the range from 0.1 to 0.5 millimeters.

8. A method for manufacturing an optical element, comprising the steps of:
providing a substrate having a first surface and an opposite second surface;
forming a plurality of first film layers with predetermined thickness or layer number on the first surface, thereby forming a first film stack on the first surface; and
forming a plurality of second film layers with same thickness or layer number stack on the second surface, thereby forming a second film stack on the second surface.

9. The method for manufacturing an optical element in accordance with claim 8, wherein the first film stack and the second film stack are formed by ion coating, radio frequency sputtering, vacuum evaporating, or chemical vapor depositing process.

10. The method for manufacturing an optical element in accordance with claim 8, wherein the first film stack and the second film stack are formed by alternately depositing high refractive index film layers and low refractive index film layers in a predetermined order.
